(19) United States
(12) Patent Application Publication
(10) Pub. No.: US 2011/0235674 A1
(43) Pub. Date: Sep. 29, 2011

(54) TEMPERATURE SENSING DEVICE

(75) Inventor: Song-Lin Tong, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/768,710

(22) Filed: Apr. 27, 2010

(30) Foreign Application Priority Data
Mar. 23, 2010 (CN) 201010130472.0

(51) Int. Cl. G01K 13/00; G01K 1/14; G01J 5/28

(52) U.S. Cl. 374/121; 374/152; 374/E13.001; 374/E01.018

(57) ABSTRACT

A temperature sensing device is configured for sensing a temperature of electrical elements disposed on a printed circuit board (PCB) and includes a fixing frame, two guiding rails, a sliding rail, a temperature sensor, a driving device, and a processor. The fixing frame is configured for framing the PCB. The guiding rails are parallelly disposed on the fixing frame. The sliding rail is perpendicularly and slidably disposed between the two guiding rails. The temperature sensor is movably disposed on the sliding rail and configured for sensing the temperature of the electrical elements. The driving device is configured for driving the sliding rail and the temperature sensor to slide along the guiding rails and the sliding rail correspondingly. The processor is connected with the temperature sensor and the driving device and configured for storing positions of the electrical elements and controlling the driving device based on the stored positions.

### BACKGROUND

1. Technical Field

The present disclosure relates to sensing devices and, particularly, to a temperature sensing device for sensing temperatures of a plurality of electrical elements disposed on a printed circuit board (PCB).

2. Description of Related Art

When building a PCB, it is necessary to check temperatures of a number of electrical elements disposed on the PCB. Conventionally, a number of thermistors are connected to the electrical elements respectively to sense the temperature of the electrical elements. However, it consumes much time to connect the thermistors and the electrical elements one by one.

Therefore, it is desirable to provide a temperature sensing device, which can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a printed circuit board, according to an exemplary embodiment.

FIG. 2 is a schematic view of a temperature sensing device, according to an exemplary embodiment of the disclosure.

FIG. 3 is a functional block diagram of a processor of the temperature sensing device of FIG. 2.

### DETAILED DESCRIPTION

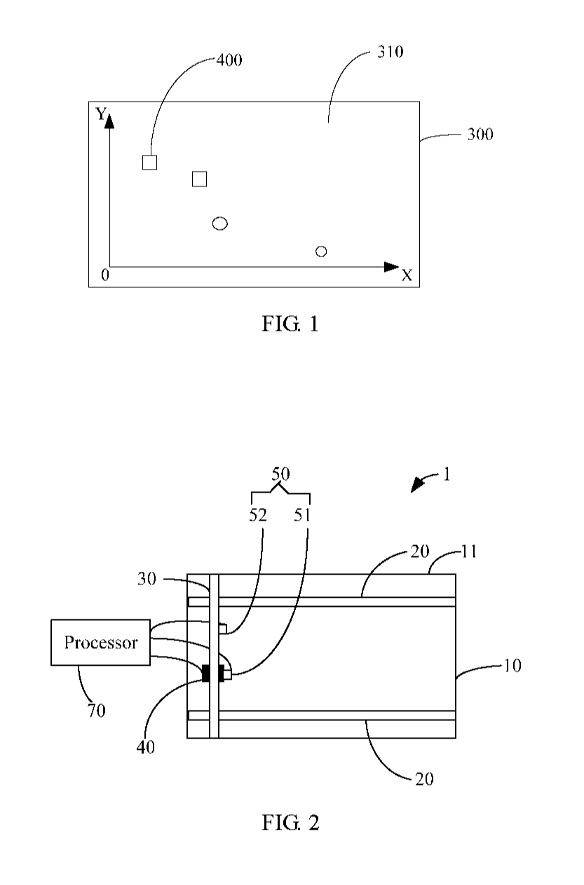

Referring to FIG. 1 and FIG. 2, a temperature sensing device 1 is configured for sensing temperatures of a number of electrical elements 400 disposed on a printed circuit board (PCB) 300. The PCB 300 is rectangular and includes a connecting surface 310 configured for fixing the electrical elements 400. The temperature sensing device 1 includes a fixing frame 10, two guiding rails 20, a sliding rail 30, a temperature sensor 40, a driving device 50, and a processor 70.

The fixing frame 10 is also rectangular and shaped corresponding to the PCB 300. The fixing frame 10 includes four side bars 11 for bounding the corresponding sides of the PCB 300.

The two guiding rails 20 are parallelly disposed on two opposite sides of the fixing frame 10. The sliding rail 30 is perpendicularly and slidably disposed across the two guiding rails 20.

The temperature sensor 40 is movably disposed on the sliding rail 30 and configured for sensing the temperatures of the electrical elements 400. In this embodiment, the temperature sensor 40 is an infrared temperature sensor.

The driving device 50 includes a first motor 51 and a second motor 52. The first motor 51 is disposed on the temperature sensor 40 and configured for driving the temperature sensor 40 to slide along the sliding rail 30. The second motor 52 is disposed on the sliding rail 30 and configured for driving the sliding rail 30 to slide along the guiding direction of the guiding rails 20.

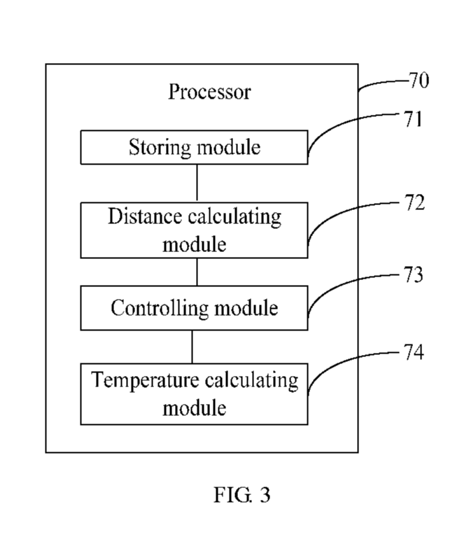

Referring to FIG. 3, the processor 70 is connected to the temperature sensor 40, the first motor 51 and the second motor 52. The processor 70 includes a storing module 71, a distance calculating module 72, a controlling module 73, and a temperature calculating module 74. The storing module 71 is configured for storing coordinates of the electrical elements 400 (see below). The distance calculating module 72 is configured for calculating the distances between the temperature sensor 40 and the electrical elements 400. The controlling module 73 is configured for controlling the first motor 51 and the second motor 52 to rotate according to the calculated distances and directions. The temperature calculating module 74 is configured for averaging the temperatures sensed by the temperature sensor 40 and storing the averaged temperature in the storing module 71.

In use, the PCB 300 is fit into the fixing frame 10 and the temperature sensing device 1 is initialized, e.g. the temperature sensor 40 is moved to the origin O of an OXY coordinate system established on FIG. 1. The layout (i.e., positions of the electrical elements 400) of the PCB 300 is determined during the building of the PCB 300, therefore once the OXY coordinate system is established, the coordinates of the electrical elements 400 in the OXY coordinate system can be determined and the coordinates can be input into the storing module 71 to initialize the temperature sensing device 1. In this embodiment, the origin of the OXY coordinate system is set at a bottom left corner of the PCB 300, the X axis extends along the guiding rails 20, and the Y axis extends along the sliding rail 30. The distance calculating module 72 respectively calculates the distances along X axis and Y axis between the electrical elements 400 and the origin O. The driving device 50 controls the first motor 51 and the second motor 52 to drive the temperature sensor 40 to arrive at the electrical elements 400. The temperature sensor 40 senses the temperature of the electrical elements 400 one by one and stores the temperatures in the storing module 71. The temperature calculating module 74 averages the temperatures and saves the averaged temperature represented as the actual temperature of the electrical elements 400 stored in the storing module 71.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A temperature sensing device comprising:
a fixing frame for framing a printed circuit board with a plurality of electrical elements mounted on the printed circuit board;
two guiding rails parallelly disposed on the fixing frame;
a sliding rail perpendicularly and slidably disposed on the two guiding rails;
a temperature sensor movably disposed on the sliding rail and configured for sensing a temperature of the electrical elements;
a driving device configured for driving the temperature sensor to slide along the sliding rail and driving the sliding rail along the guiding rails;
a processor connected to the temperature sensor and the driving device and configured for storing positions of the electrical elements and controlling the driving device according to the positions.

2. The temperature sensing device in claim 1, wherein the processor comprised
a storing module configured for storing the coordinate locations of the electrical elements;
a distance calculating module configured for calculating the distances between the temperature sensor and the electrical elements;
a controlling module configured for controlling the driving device according the data calculated by the distance calculating module.

3. The temperature sensing device in claim 2, wherein the processor also comprised a temperature calculating module configured for averaging the temperatures sensed by the temperature sensor and storing the averaged temperature in the storing module.

4. The temperature sensing device in claim 1, wherein the driving device comprised a first motor and a second motor, the first motor is disposed on the temperature sensor and configured for driving the temperature sensor to slide along the sliding rail, the second motor is disposed on the sliding rail and configured for driving the sliding rail to slide along the guiding rail.

5. The temperature sensing device in claim 1, wherein the temperature sensor is an infrared temperature sensor.
